(19) United States
(12) Patent Application Publication
(10) Pub. No.: US 2016/0027224 A1
(43) Pub. Date: Jan. 28, 2016

(54) Method and Apparatus for Vehicle Data Monitoring

(71) Applicant: Ford Global Technologies, LLC, Dearborn, MI (US)

(72) Inventors: Stefan Bankowski, Royal Oak, MI (US); Timur Pulathaneli, Cologne (DE); Kevin Burdette, Plymouth, MI (US)

(21) Appl. No.: 14/444,310

(22) Filed: Jul. 28, 2014

(51) Int. Cl. G07C 5/00; G07C 5/08

(52) U.S. Cl. CPC G07C 5/008; G07C 5/0841

(57) ABSTRACT

A system includes a wireless device processor configured to communicate with a vehicle computing system over a wireless communication link to obtain vehicle data. The processor is also configured to compare obtained vehicle data to predetermined thresholds to determine if reporting is appropriate and report data to a user via a wireless device when obtained vehicle data comparison indicates that reporting is appropriate, based on the data exceeding a threshold.

### TECHNICAL FIELD

The illustrative embodiments generally relate to a method and apparatus for vehicle data monitoring.

### BACKGROUND

Connected vehicle systems provide opportunities for advanced user interaction with vehicles. Users can download navigation directions, download media, and access remote servers and services from within the vehicle. Also, advanced vehicle computers can provide advanced vehicle data to users. Users can also use phone based applications to interact with vehicle computers on a variety of levels.

For example, U.S. Pat. No. 8,014,915 generally relates to a vehicle management system using a wireless network system the system comprising, a WCDMA service unit having a specified ID and obtaining access to a network wirelessly, an ECU system associated with the WCDMA service module for controlling all kinds of interfaces in a vehicle, a service provider for providing various services when the WCDMA service module is connected to the wireless network, and a user having the services through non-wireless or wireless communication inside or outside of the vehicle.

U.S. Pat. No. 8,532,574 generally relates to an in-vehicle system that may detect an occurrence of a triggering event, detect a short-range communication connection between the in-vehicle system and a mobile communication device, send a prompt, including a request for information, to the mobile communication device, and receive a response, including the requested information, from the mobile communication device via the short-range communication module. In some embodiments, a business review, an advertisement, or a redeemable electronic coupon may be sent to the mobile communication device after the requested information is provided. Furthermore, destination information may be shared between the in-vehicle system and the mobile communication device in response to the triggering event.

U.S. Application 2013/0144471 generally relates to a system and method for managing a vehicle by using a mobile terminal. The mobile terminal includes: a vehicle verification unit that receives information for verifying a vehicle management terminal and verifies the vehicle management terminal based on the received information; a terminal information collecting unit for collecting information regarding control of a vehicle.

### SUMMARY

In a first illustrative embodiment, a system includes a wireless device processor configured to communicate with a vehicle computing system over a wireless communication link to obtain vehicle data. The processor is also configured to compare obtained vehicle data to predetermined thresholds to determine if reporting is appropriate and report data to a user via a wireless device when obtained vehicle data comparison indicates that reporting is appropriate, based on the data exceeding a threshold.

In a second illustrative embodiment, a computer implemented method includes communicating with a vehicle computing system over a wireless communication link to obtain vehicle data. The method also includes comparing obtained vehicle data to predetermined thresholds to determine if reporting is appropriate and, when obtained vehicle data comparison indicates that reporting is appropriate, based on the data exceeding a threshold, reporting data to a user via a wireless device.

In a third illustrative embodiment, a non-transitory computer readable storage medium stores instructions that, when executed by a vehicle computer, cause the vehicle computer to perform a method including communicating with a vehicle computing system over a wireless communication link to obtain vehicle data. The method also includes comparing obtained vehicle data to predetermined thresholds to determine if reporting is appropriate and, when obtained vehicle data comparison indicates that reporting is appropriate, based on the data exceeding a threshold, reporting data to a user via a wireless device.

### BRIEF DESCRIPTION OF THE DRAWINGS

FIG. 1 shows an illustrative vehicle computing system;

FIG. 2 shows an illustrative data gathering process;

FIG. 3 shows an illustrative notification process;

FIG. 4 shows an illustrative data gathering and alert process;

FIG. 5 shows an illustrative alert presentation process; and

FIG. 6 shows an illustrative configuration process.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

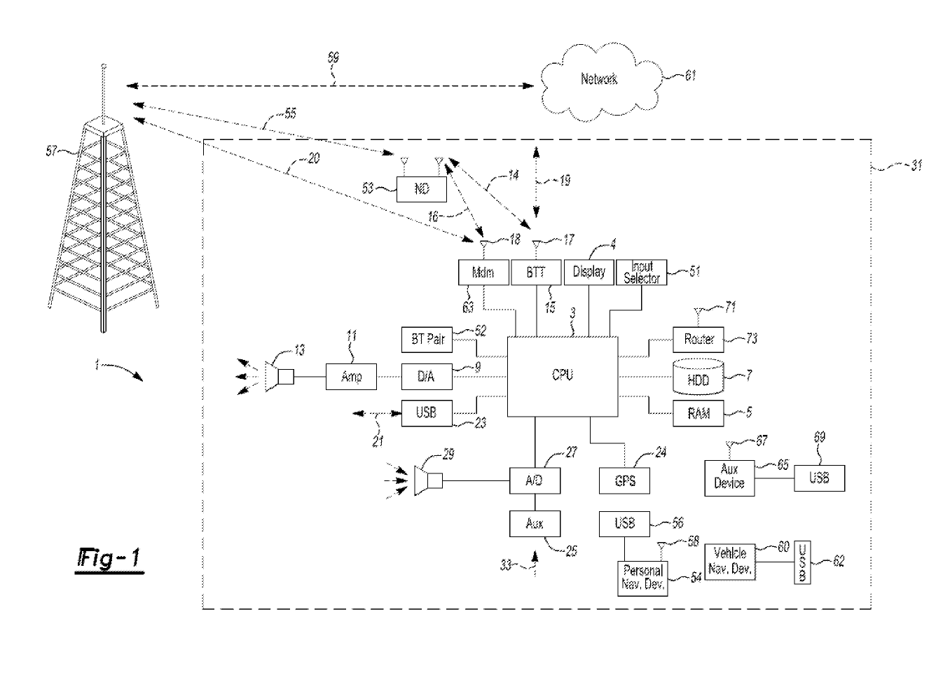

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, spoken dialog system with automatic speech recognition and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory. In general, persistent (non-transitory) memory can include all forms of memory that maintain data when a computer or other device is powered down. These include, but are not limited to, HDDs, CDs, DVDs, magnetic tapes, solid state drives, portable USB drives and any other suitable form of persistent memory.

The processor is also provided with a number of different inputs allowing the user to interface with the processor. In this illustrative embodiment, a microphone 29, an auxiliary input 25 (for input 33), a USB input 23, a GPS input 24, screen 4, which may be a touchscreen display, and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of Code Domain Multiple Access (CDMA), Time Domain Multiple Access (TDMA), Space-Domain Multiple Access (SDMA) for digital cellular communication. These are all ITU IMT-2000 (3G) compliant standards and offer data rates up to 2 mbs for stationary or walking users and 385 kbs for users in a moving vehicle. 3G standards are now being replaced by IMT-Advanced (4G) which offers 100 mbs for users in a vehicle and 1 gbs for stationary users. If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (FireWire™ (Apple), i.LINK™ (Sony), and Lynx™ (Texas Instruments)), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a WiFi (IEEE 803.11) 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing the process, since the wireless device would not “send and receive” information with itself. One of ordinary skill in the art will understand when it is inappropriate to apply a particular VACS to a given solution. In all solutions, it is contemplated that at least the vehicle computing system (VCS) located within the vehicle itself is capable of performing the exemplary processes.

In each of the illustrative embodiments discussed herein, an exemplary, non-limiting example of a process performable by a computing system is shown. With respect to each process, it is possible for the computing system executing the process to become, for the limited purpose of executing the process, configured as a special purpose processor to perform the process. All processes need not be performed in their entirety, and are understood to be examples of types of processes that may be performed to achieve elements of the invention. Additional steps may be added or removed from the exemplary processes as desired.

The illustrative embodiments describe the interaction between an application designed to run, for example, on a mobile device, and a vehicle computing system. The application can be a passive, background application, that runs when a user is in a vehicle. If state-based application launching is available on the mobile device, then the application can be enabled to run when a mobile device is in communication with a vehicle computing system.

The application runs in the background and passively gathers data from the vehicle. This can be any variety of data available for the application, including, but not limited to, fuel levels, oil health, vehicle system health, miles per gallon, vehicle fuel efficiency, driving behavior, speed profiling, or any other suitable information accessible from a vehicle network or that can be made available to a vehicle user. The list presented above is by no means exhaustive, and it will be understood that any data that can be reasonable made available from a vehicle system could be provided to the application for data gathering purposes.

The application can serve to remind users that oil changes or refueling (or other maintenance) is needed, based on observed vehicle data. It can also alert parents to the behavior of children driving a vehicle. Custom data gathering configurations can be set, and custom thresholds for behavior changes (e.g., reporting points) can be established on a user basis. In this manner, each user can tailor the application to suit their particular needs.

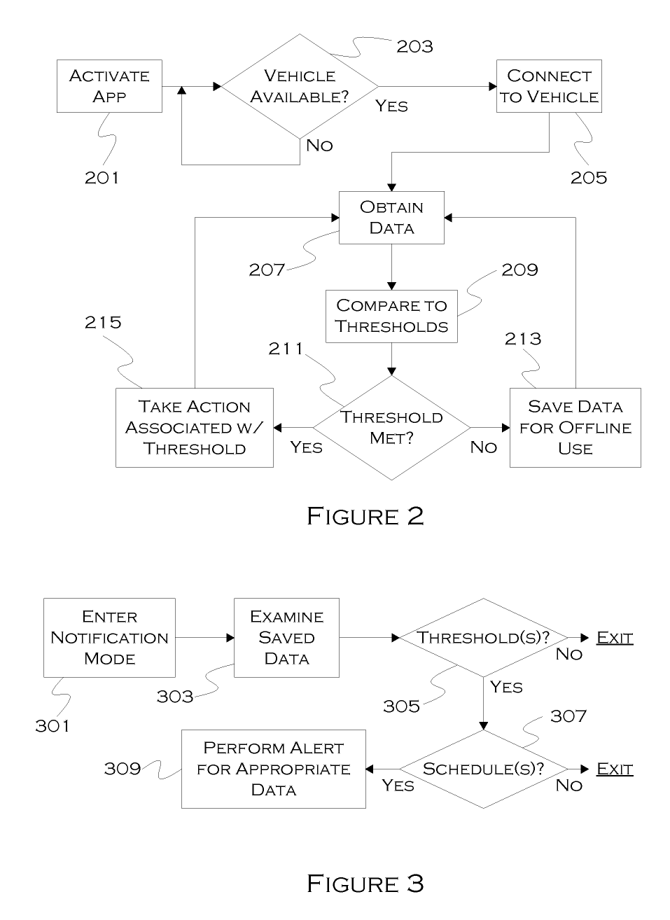

FIG. 2 shows an illustrative data gathering process. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

This is one illustrative example of a general process for gathering data from the vehicle. In this process, the application resides on the phone and communicates with a vehicle computer. Data from vehicle computer networks and/or systems can be transferred to the application as permissible/appropriate.

At some point, whether user initiated or initiated, for example, by virtue of being in communication with the vehicle, the application is activated 201. If the user initiated the application, a vehicle connection may not currently be available 203, so the application can go into waiting mode until connection with a vehicle is available.

Once a connection with the vehicle has been established 205, the process can communicate with one or more vehicle networks and/or processors to gather data from the vehicle and its various subsystems and modules 207. This data can encompass any appropriate data, such as, but not limited to, fuel levels, oil status, component status, and even data such as seat belt fastenings for detected passengers.

The data may be usable offline (i.e., when the user is not in and connected to the vehicle) for a variety of purposes. Maintenance reminders for appropriate systems can be sent on user-defined schedules, a child's driving and safety behaviors can be examined, and users can generally check on data such as fuel consumption to determine if they are maximizing vehicle capability (or when shopping for a comparable vehicle). Some data may also be useful while the connection is still established, such as, but not limited to, providing alerts relating to a child's driving behavior.

For any data relating to reporting, there is typically a threshold established. For example, with a low fuel level, the user may establish a threshold of 20% for reporting. For an oil life level, the user may establish a threshold of 500 miles remaining For child monitoring, the user may establish a threshold of 10 mph over a known speed limit, or a certain maximum speed. The user may also establish a threshold of more than 2 minutes since entering the vehicle without one or more seatbelts fastened. These are purely examples of thresholds, and are not intended to limit the specification in any manner. They merely serve to show the type of thresholds that might be established by a user.

Relevant gathered data is compared to any established thresholds for that data 209. If a threshold is met for any gathered data 211, the process may take an action associated with the threshold 213. In the fuel case, a reminder to get fuel may be sent at some point when the user is not in the vehicle (since the reminder provided by the vehicle itself may be useful enough to remind the user while the user is still in the vehicle). Similarly, an oil or other maintenance reminder may be sent while the user is not in the vehicle. These reminders can have a timing parameter associated therewith as well, again, user configurable if desired. For example, a reminder that general maintenance needs to be performed will not likely be too useful on a Tuesday afternoon, while the user is at work, but may be better sent on the weekend, when the user has time to deal with the issue. By allowing the user to associate reminder timing, the process can not only provide useful data, but can provide it at a useful time.

FIG. 3 shows an illustrative notification process. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In this illustrative example, the process executes behaviors when the system is not connected to a vehicle computer. This illustrative process demonstrates how an application having gathered vehicle data can provide useful information to the user when the user is not in a vehicle.

In this example, the process enters a notification mode (which may be run periodically or enabled when needed, such as when preset times for notification occur) 301. When in the notification mode, the process examines any data saved from communication with the vehicle 303. This can be all saved data, or, for example, if the process is activated based on a notification time, then only data related to the notification time may be examined. For example, if the user wants to be notified on the weekend with maintenance issues, then when the set time arrives, the process may examine maintenance related data. In other instances, the process may examine all saved data in case other notifications may be needed.

If any thresholds are met with respect to the examined data 305, the process may also check to see if there are any scheduling parameters set for each met threshold 307. This prevents notification or action on items when they are not scheduled to be acted upon. If there are scheduling parameters met (or if no scheduled parameters exist), the process can perform an alert (or other appropriate action) for the observed threshold meeting data.

Also, some data may have no threshold associated therewith, but may have a schedule. For example, a user may want to know what weekly fuel efficiency was obtained each week. In such an instance, at the set time (e.g., 5PM Sunday), the process may notify the user of observed fuel efficiency for the week. Other relevant data may also be shown, relating to reported data, so that any desired comparisons can be made (e.g., in the fuel efficiency case, data relating to monthly, vehicle-life, etc. fuel efficiency).

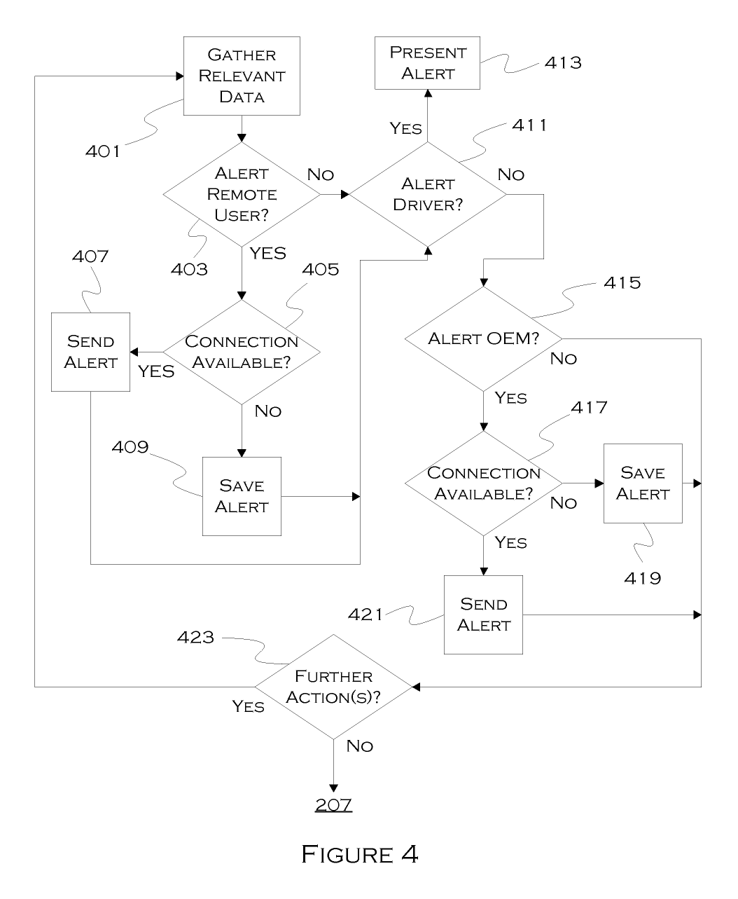

FIG. 4 shows an illustrative data gathering and alert process. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In this illustrative example, the process can both gather data and perform reporting functions if necessary. For example, without limitation, a process running on a child's phone may interact with the vehicle to provide reporting to a parent when and if needed.

In this example, the process may gather relevant data 401 relating to any parameters set for data gathering 401. These can be default or user-defined parameters. If any of the gathered data meets any set designations/thresholds, it may be desirable to report the data to one or more sources.

For example, if a parent wished to monitor the top speed of a child, a top speed of 80 mph may be set. If the gathered data ever indicates that a speed of over 80 mph is achieved, the process may be configured to report to a remote user 403.

In such an instance, the process may check to see if a connection is available, through a cloud server, for example, to report to a remote user 405. In other instances, the process may simply use a text message or other medium, where the process can be relatively assured of connectability.

If the connection is available, the process may send an alert to the appropriate party 407. The alert can contain the parameter met, the gathered data, a time of day, a time over parameter (for the speeding example, “10 minutes driving over 80 mph” could be sent), and any other relevant data useful in the reporting. If no connection is available, the process may simply save the data for later reporting when a connection is available 409.

In some instances, it may also be desirable to report data to a driver 411. If the process is connected to the vehicle, it can instruct the vehicle to report to the driver through a vehicle display, so as not to distract the driver with unnecessary phone usage. If a parameter for reporting to a driver is set 411, the process may also report the message to the driver 413. In the “speeding example,” the process may not only report to a parent, but may also report to the driver, so that excessive speeds can be mitigated. Notifying the driver, in appropriate instances, may be useful to change driving behavior or cause the driver to take appropriate action.

For example, if a driver has a notification that fuel below 20% or oil with less than 500 miles remaining is present, the process may be configured to report this information offline at an appropriate time. But, since the driver is also currently in the vehicle, the process may also instruct present reporting of the data to the driver, in case the driver has time to address the issue now, and avoid having to address the issue later.

Also, in this example, it may be desirable to report certain vehicle data to an OEM. Unexpectedly low fuel efficiency or shortened oil life may be reported to an OEM, for example, to help the OEM understand possible problems with a specific vehicle or vehicle model. By saving this data, when the customer arrives at the dealer, anomalies can be addressed with maintenance, which the driver may not have even been aware was needed.

If any OEM reporting is needed 415, the process will again check to see if a connection is available 417. If the connection is available, the process can report to the OEM 421. Otherwise, the process may wait on reporting 419 until such time as a connection is available.

If other reporting needs to be done 423, the process can perform the reporting accordingly by repeating, otherwise the process may exit at this time.

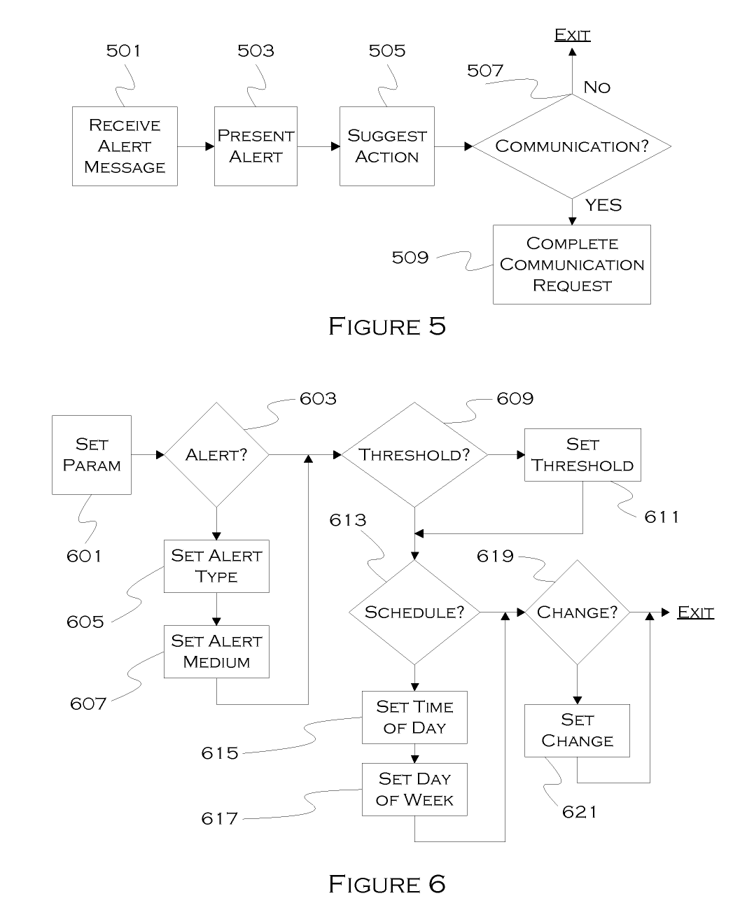

FIG. 5 shows an illustrative alert presentation process. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In this illustrative example, a process for reporting on the back end is presented. This can be, for example, a report sent to a parent or monitoring user's phone. In this example, the application running on the device remote from the vehicle receives a report message from the application running on the device in communication with the vehicle 501.

The alert or notification is presented in the appropriate manner, such as, but not limited to, an alert message on a mobile device display 503. Also, if any action might be appropriate (schedule dealer visit, call driver, etc.), the process can suggest an appropriate action 505. The action could be configured, for example, in conjunction with setting the parameters for reporting. In other instances, certain reporting (such as maintenance notification) can be set automatically with respect to the reporting type.

If any action, such as communication 507, is suggested, the process may present an option for communication (or other appropriate further action). If agreed upon by the user, the process may complete the communication request (by calling the recommended number, for example) or may complete any other appropriate action.

FIG. 6 shows an illustrative configuration process. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In this illustrative example, a user can configure various aspects of the data gathering application to provide maximum utility to a user. While not exhaustive by any means, an illustrative example of possible settings for data elements is shown.

In this example, the user enters a configuration phase and elects a certain parameter for modification 601. By way of example, and not limitation, fuel level will be used to illustrate a real-world example of this process. After the user selects the fuel level parameter, the user can choose whether or not to set an alert 603 to be associated with a fuel level state.

In this example, if the alert is selected, the user can then set the forms of alert notification 605. These can include, but are not limited to, text messages, phone displayed messages, in vehicle notification, etc. Mediums for alerts (vehicle, PC, phone, etc.) can also be chosen if appropriate 607. So, for example, a user may select to “display alert message” as an alert type, and may select vehicle and phone for the particular display mediums.

Also, the user has the option to set a threshold with the parameter, to determine when an alert should be displayed 609. In this example, if the threshold parameter is selected, one or more thresholds may be set 611. In the fuel example, the user could set a single reminder at a 20% threshold, and a constant reminder at a 5% threshold.

Further, in this example, the user can schedule timing for alerts 613. While an in-vehicle alert may always be presented, regardless of timing, the user may wish to schedule phone alerts for times that may be useful. For example, with respect to fuel, the user may wish to schedule fuel notifications for 10 minutes before a work day ends (e.g., 4:50 PM) so that the user is reminded that fuel should be planned into the trip home. With respect to the scheduling, the user may set a time of day 615 and a day of week 617. Other appropriate parameters may also be set.

The user may also wish to set a change in behavior associated with an alert 619. For example, in a low-charge state for a battery electric vehicle, the user may wish to limit accessory usage when the alert occurs until the battery is charged. Any appropriate state changes can be set 621 to correspond to the appropriate alerts.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
a wireless device processor configured to:
communicate with a vehicle computing system over a wireless communication link to obtain vehicle data;
compare obtained vehicle data to predetermined thresholds to determine if reporting is appropriate; and
report data to a user via a wireless device when obtained vehicle data comparison indicates that reporting is appropriate, based on the data exceeding a threshold.

2. The system of claim 1, wherein the vehicle data includes fuel remaining data.

3. The system of claim 1, wherein the vehicle data includes maintenance data.

4. The system of claim 3, wherein the maintenance data includes oil life data.

5. The system of claim 1, wherein the thresholds are user-configured.

6. The system of claim 1, wherein the reporting includes reporting to a wireless device other than a wireless device containing the wireless device processor.

7. The system of claim 1, wherein the reporting further includes the wireless device processor being configured to instruct the vehicle computing system to report, via a vehicle display, to a driver.

8. A computer implemented method comprising:
communicating with a vehicle computing system over a wireless communication link to obtain vehicle data;
comparing obtained vehicle data to predetermined thresholds to determine if reporting is appropriate; and
when obtained vehicle data comparison indicates that reporting is appropriate, based on the data exceeding a threshold, reporting data to a user via a wireless device.

9. The method of claim 8, wherein the vehicle data includes fuel remaining data.

10. The method of claim 8, wherein the vehicle data includes maintenance data.

11. The method of claim 10, wherein the maintenance data includes oil life data.

12. The method of claim 8, wherein the thresholds are user-configured.

13. The method of claim 8, wherein the reporting includes reporting to a wireless device other than a wireless device performing the method.

14. The method of claim 8, wherein the reporting further includes instructing the vehicle computing system to report, via a vehicle display, to a driver.

15. A non-transitory computer readable storage medium, storing instructions that, when executed by a vehicle computer, causes the vehicle computer to perform a method comprising:
communicating with a vehicle computing system over a wireless communication link to obtain vehicle data;
comparing obtained vehicle data to predetermined thresholds to determine if reporting is appropriate; and
when obtained vehicle data comparison indicates that reporting is appropriate, based on the data exceeding a threshold, reporting data to a user via a wireless device.

16. The storage medium of claim 15, wherein the vehicle data includes fuel remaining data.

17. The storage medium of claim 15, wherein the vehicle data includes maintenance data.

18. The storage medium of claim 15, wherein the thresholds are user-configured.

19. The storage medium of claim 15, wherein the reporting includes reporting to a wireless device other than a wireless device executing the stored instructions.

20. The storage medium of claim 15, wherein the reporting further includes instructing the vehicle computing system to report, via a vehicle display, to a driver.
